(19) United States
(12) Patent Application Publication
(10) Pub. No.: US 2005/0202388 A1
(43) Pub. Date: Sep. 15, 2005

(54) Method and apparatus for remote interaction with a computer over a network

(76) Inventors: Michael A. Zuhl, Lake Oswego, OR (US); Jonathan E. Steinhart, McMinnville, OR (US)

Correspondence Address: SMITH-HILL AND BEDELL, P.C., 16100 NW CORNELL ROAD, SUITE 220, BEAVERTON, OR, 97006, US

(21) Appl. No.: 11/029,206

(22) Filed: Jan. 3, 2005

Related U.S. Application Data
(60) Provisional application No. 60/552,230, filed on Mar. 11, 2004.

(51) Int. Cl. G09B 23/28

(52) U.S. Cl. 434/350; 434/118

(57) ABSTRACT

A remote access device is disclosed for remote interaction with a computer. A local computer transmits graphics data to a remote station over a network. The remote station transmits keyboard and mouse data to the local computer over a network. The remote access device is a circuit module that is connected to the local computer. This module facilitates the transmission of graphics data, keyboard data, and mouse data.

### CROSS-REFERENCE TO RELATED APPLICATIONS

This application claims the benefit of Provisional Application No. 60/552,230 filed Mar. 11, 2004, the entire disclosure of which is hereby incorporated by reference herein for all purposes. Subject matter disclosed in this application might be considered to be related to subject matter disclosed in Patent Application Nos. (Attorney Docket ZUHL 2849) and (Attorney Docket ZUHL 2851), the entire disclosure of each of which is hereby incorporated by reference herein for all purposes.

### BACKGROUND OF THE INVENTION

This invention relates to remote computer access.

The need to access computers from remote locations frequently arises. For example, a system administrator may desire to control a rack of systems from a location other than a noisy or inconveniently secure machine room, or even from home.

Early computer architectures made this fairly easy to do. All input and output from the computer could be directed over a single, low-bandwidth console serial interface. A remote display could easily be connected using a long cable or a modem.

Modern computer architectures, most notably the IBM PC architecture, utilize graphical consoles. The output from these computers is high bandwidth analog or digital video which is usually connected to a local video monitor. Serial PS/2 or USB interfaces are used for keyboard and mouse input. These interfaces are not suitable for long distance transmission.

The operation of PC architecture computers takes place in several stages. On power-up, the BIOS displays start-up messages on the console. A number of different configuration dialogs may be entered. A boot loader may be invoked through which the user may select an operating system. The operating system then starts up, generating various messages. A large variety of programs may then be run on top of the operating system. Upon exiting the operating system a number of shut-down messages are displayed on the console.

Several software packages exist that facilitate remote access. Some of these packages use standard networking protocols so that a remote display can be an almost unlimited distance from the computer. However, these packages run on top of the operating system and therefore cannot handle the start-up, configuration, boot loader, operating system start-up, and shut-down messages. Therefore, software packages don't work, for example, in an application where a remote access is desired for system configuration.

Hardware support for remote access exists in the form of keyboard, mouse, and video extension cables and repeaters. KVM (Keyboard, Video, Mouse) switches that allow a single keyboard, mouse, and monitor to be shared by multiple computers are in this category. Some products digitize the signals for transmission over moderately longer but still limited distances. Such hardware does not have the software limitation of requiring the operating system to be running. However, while they allow remote access further from the computer, the distance is effectively limited to hundreds of feet.

Some computers include internal serial-over-LAN capability that allows some control over a network. These solutions do not provide full functionality, and only provide access during system start-up and shut-down.

### SUMMARY OF THE INVENTION

In accordance with a first aspect of the invention there is provided a remote access device for use with a local computer to allow a remote computer to interact with the local computer, said remote access device comprising a communication interface for receiving encoded human input device data from the remote computer over a communication medium, a decoder for receiving the encoded data from the communication interface and generating human input device signals, a human input device signal interface for receiving human input device signals from the decoder, and a computer interface for receiving the human input device signals from the human input device signal interface and supplying the human input device signals to the local computer.

In accordance with a second aspect of the invention there is provided a computer system comprising a local computer having a bus and a communication interface, a remote computer having a processor, a human input device for generating human input device signals, an encoder for receiving the human input device signals and generating encoded human input device data, and a communication interface, a communication medium for communicating messages from the communication interface of the remote computer to the communication interface of the local computer, and a remote access device comprising a communication interface for receiving encoded human input device data from the remote computer over the communication medium, a decoder for receiving the encoded human input device data from the communication interface and generating human input device signals, a human input device interface for receiving human input device signals from the decoder, and a computer interface for receiving the human input device signals from the human input device interface and supplying the human input device signals to the local computer, whereby the local computer responds to the human input device signals generated by the human input device of the remote computer.

In accordance with a third aspect of the invention there is provided a computer system comprising a local computer, a remote computer having a processor, a human input device for generating human input device signals, an encoder for receiving the human input device signals and generating encoded human input device data, and a communication interface, a remote access device comprising a communication interface for receiving encoded human input device data, a decoder for receiving the encoded human input device data from the communication interface and generating human input device signals, a human input device interface for receiving human input device signals from the decoder, and a computer interface for receiving the human input device signals from the human input device interface and supplying the human input device signals to the local computer, and a communication medium for communicating encoded human input device data from the communication interface of the remote computer to the communication interface of the remote access device, whereby the local computer responds to the human input device signals generated by the human input device of the remote computer.

An embodiment of this invention is a remote access device that attaches to a computer. It is indistinguishable from a standard keyboard, mouse, and console output device from the perspective of the computer. Unlike existing devices, the input and output data is in a form suitable for transmission over long haul networks. An embodiment of the invention provides the access capabilities of the hardware products in concert with the virtually unlimited distance of the software products. As an added benefit, simultaneous access from multiple remote stations is available since monitor specific timing and identification information is eliminated.

### BRIEF DESCRIPTION OF THE DRAWINGS

FIG. 1 is a schematic block diagram of an embodiment of the invention.

FIG. 2 is a block diagram of the target environment for an embodiment of the invention.

FIG. 3 is a schematic block of the environment for the preferred embodiments of the invention in the target environment.

FIG. 4 is a schematic block diagram of the hardware in the preferred embodiments of the invention. The relationship between the hardware blocks and the blocks shown in FIG. 1 is shown.

FIG. 5 is a schematic block diagram of the firmware in the preferred embodiments of the invention.

### DETAILED DESCRIPTION

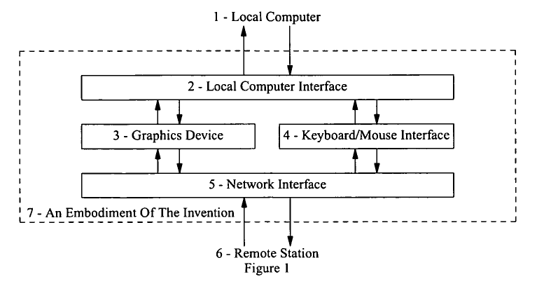

A block diagram of an embodiment of the invention is shown in FIG. 1.

An embodiment of the invention connects to a local computer 1 via the local computer interface 2.

The graphics device 3 converts commands from the local computer 1 into data suitable for transmission over the network interface 5 as described in Patent Application No. (Attorney Docket ZUHL 2849).

The keyboard/mouse interface 4 receives keyboard and mouse input from the network interface 6. It emulates standard keyboard and mouse devices that are recognized by the local computer 1 and sends this data to the local computer 1 over the local computer interface 2.

The network interface 5 allows a remote station 6 to communicate with an embodiment of the invention. It transmits display information and receives keyboard and mouse information. There may also be associated control information.

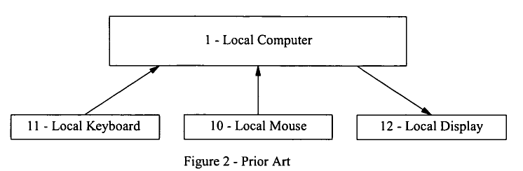

FIG. 2 shows the prior-art target environment for an embodiment of the invention. This environment is a local computer 1 connected to a local keyboard 10, local mouse 11, and local display 12. The arrows in FIG. 2 indicate the predominate flow of data; small amounts of control information may flow in the opposite direction.

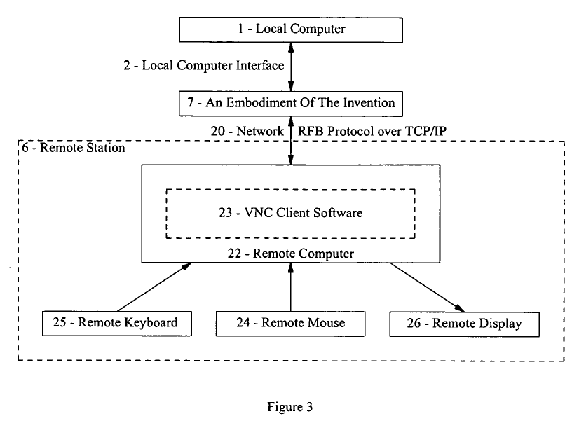

FIG. 3 shows an embodiment of the invention in its target environment. There is no local keyboard 10, local mouse 11, or local display 12 attached to the local computer 1. Instead, an embodiment of the invention 7 is connected to the local computer 1 by the local computer interface 2. Keyboard, mouse, and display data are sent to and from a remote station 6 across the network 20. Communication across the network 20 is accomplished by layering the RFB (Remote FrameBuffer) protocol used by the open source VNC (Virtual Network Console) software on top of the TCP/IP protocol. The remote station 6 is a remote computer 22 with a remote keyboard 24, remote mouse 25, and remote display 26. The remote computer 22 includes VNC client software 23. The result is that the remote keyboard 24, remote mouse 25, and remote display 26 appear to the local computer 1 as if they are a local keyboard 10, local mouse 11, and local display 12. A single remote station 6 can simultaneously operate multiple instances of an embodiment of the invention 7.

The use of industry standard Ethernet hardware and industry standard TCP/IP protocols allows the remote station 6 to be connected to the computer using commonly available, low cost hardware. The remote station 6 can be anywhere in the world since the TCP/IP protocols are the foundation of the Internet. The use of the RFB protocol and VNC software allow a remote station 6 to be easily constructed using off-the-shelf hardware and software.

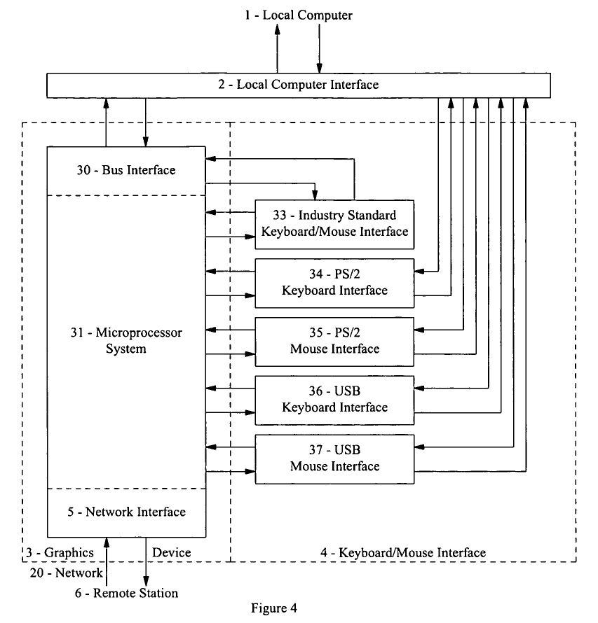

A schematic block diagram of the hardware for the preferred embodiment of the invention is shown in FIG. 4. This diagram adds detail to the overall block diagram in FIG. 1 above.

The graphics device 3 in the preferred embodiments is that which is described in Patent Application No. (Attorney Docket ZUHL 2849). This graphics device 3 includes a bus interface 30, network interface 5, and a microprocessor system 31. This embodiment of the invention leverages those components by adding additional functionality rather than duplicating those components.

The addition of the keyboard/mouse interface 4 differentiates this embodiment of the invention from Patent Application No. (Attorney Docket ZUHL 2849). Keyboard/mouse support is provided in three different ways in order to accommodate the evolution of computer architectures.

An industry standard keyboard/mouse interface 33 presents keyboard and mouse information from the remote station 6 to the local computer 1 in a form indistinguishable from an industry standard keyboard controller and industry standard mouse interface. The PS/2 keyboard interface 34 presents keyboard information from the remote station 6 to the local computer 1 in a form that is indistinguishable from an industry standard PS/2 keyboard. The PS/2 mouse interface 35 presents mouse information from the remote station 6 to the local computer 1 in a form that is indistinguishable from an industry standard PS/2 mouse. The USB keyboard interface 36 presents keyboard information from the remote station 6 to the local computer 1 in a form that is indistinguishable from an industry standard USB keyboard. The USB mouse interface 37 presents mouse information from the remote station 6 to the local computer 1 in a form that is indistinguishable from an industry standard USB mouse.

The combination of the bus interface 30 and the keyboard/mouse interface 4 signals is the local computer interface 2.

An embodiment of the invention communicates with a remote station 6 across the network 20.

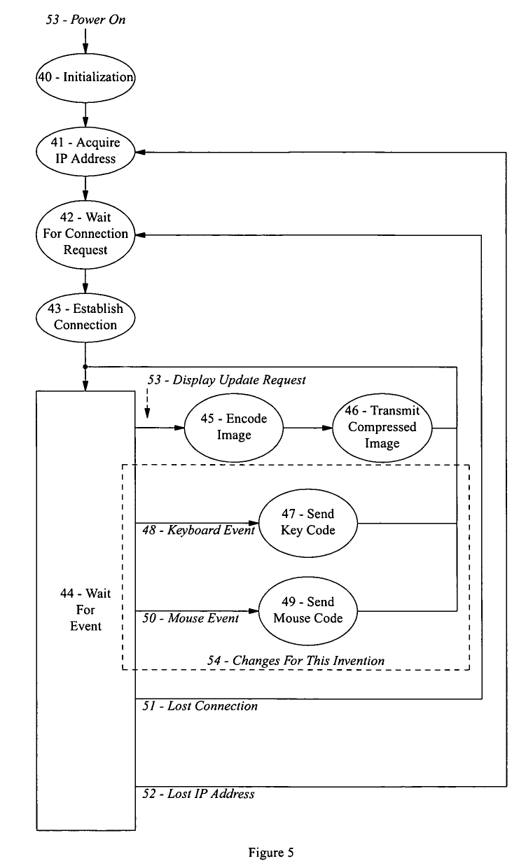

FIG. 5 is a block diagram of the firmware in the preferred embodiments of the invention.

The firmware performs initialization 40 after power on 53.

The initialized system has an Ethernet address set by the network interface 5. It maps that to an IP (Internet Protocol) address in the acquire IP address 41 block. There are several possible ways to acquire an IP address due to the evolution of the Internet. The system tries to acquire an address using DHCP, RARP, and BOOTP.

A remote station 6 can connect to an embodiment the invention once an IP address is established. An embodiment of the invention waits for a request from the remote station 6 in the wait for connection request block 42.

A connection with the remote station 6 is established in the establish connection block 43 after a connection request is received. This may include handshaking to agree on compression methods and data formats that can be handled by both ends of the connection.

Steady state operation begins once the connection is established. An embodiment of the invention waits for an internal or external event as shown in wait for event 44 and then processes the event. There are five events:

1. A lost IP address 52, in which case the system goes back to 41 to get a new one,

2. A lost connection 51, in which case the system goes back to 42 to get a new one, or

3. A keyboard event 48 is received from the remote station 6 across the network 20. Send key code 47 translates this event into a key code recognized by the local computer 1 and sends that code to the local computer 1.

4. A mouse event 50 is received from the remote station 6 across the network 20. Send mouse code 49 translates this event into a mouse code recognized by the local computer 1 and sends that code to the local computer 1.

5. A display update request 53 is received from the remote station 6 across the network 20. New image data is sent to the remote station 6. The data is first encoded by encode image 45 and then sent to the remote station 6 by transmit compressed image 46.

The changes for this invention 54 firmware blocks are the only firmware changes to Patent Application No. (Attorney Docket ZUHL 2849) required for this embodiment of the invention.

It will be appreciated that the invention is not restricted to the particular embodiment that has been described, and that variations may be made therein without departing from the scope of the invention as defined in the appended claims and equivalents thereof. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. A remote access device for use with a local computer to allow a remote computer to interact with the local computer, said remote access device comprising:
a communication interface for receiving encoded human input device data from the remote computer over a communication medium,
a decoder for receiving the encoded data from the communication interface and generating human input device signals,
a human input device signal interface for receiving human input device signals from the decoder, and
a computer interface for receiving the human input device signals from the human input device signal interface and supplying the human input device signals to the local computer.

2. A computer system comprising:
a local computer having a bus and a communication interface,
a remote computer having a processor, a human input device for generating human input device signals, an encoder for receiving the human input device signals and generating encoded human input device data, and a communication interface,
a communication medium for communicating messages from the communication interface of the remote computer to the communication interface of the local computer, and
a remote access device comprising a communication interface for receiving encoded human input device data from the remote computer over the communication medium, a decoder for receiving the encoded human input device data from the communication interface and generating human input device signals, a human input device interface for receiving human input device signals from the decoder, and a computer interface for receiving the human input device signals from the human input device interface and supplying the human input device signals to the local computer,
whereby the local computer responds to the human input device signals generated by the human input device of the remote computer.

3. A computer system according to claim 2, wherein the human interface device of the remote computer comprises at least one of a keyboard and a pointing device.

4. A computer system comprising:
a local computer,
a remote computer having a processor, a human input device for generating human input device signals, an encoder for receiving the human input device signals and generating encoded human input device data, and a communication interface,
a remote access device comprising a communication interface for receiving encoded human input device data, a decoder for receiving the encoded human input device data from the communication interface and generating human input device signals, a human input device interface for receiving human input device signals from the decoder, and a computer interface for receiving the human input device signals from the human input device interface and supplying the human input device signals to the local computer, and
a communication medium for communicating encoded human input device data from the communication interface of the remote computer to the communication interface of the remote access device,
whereby the local computer responds to the human input device signals generated by the human input device of the remote computer.

5. A computer system according to claim 4, wherein the human interface device of the remote computer comprises at least one of a keyboard and a pointing device.
